(19) United States
(12) Patent Application Publication
(10) Pub. No.: US 2013/0145591 A1
(43) Pub. Date: Jun. 13, 2013

(54) PRESSING DISC FOR DISASSEMBLING BEARINGS

(71) Applicant: Yu-Lin CHEN, Taichung City (TW)

(72) Inventor: Yu-Lin CHEN, Taichung City (TW)

(21) Appl. No.: 13/324,266

(22) Filed: Dec. 13, 2011

(51) Int. Cl. B25B 27/06; B23P 19/04

(52) U.S. Cl. 29/256

(57) ABSTRACT

A pressing disc for disassembling bearings includes three arc members each has a clamp portion and a through hole on each of two sides thereof. The three arc members are coupled with each other to allow any one through hole of any one arc member to communicate with the opposing through hole of the neighboring arc member to form a channel. The three clamp portions are connected with each other to form a clamp space. The pressing disc also has three penetrating rods respectively running through the channel. Each penetrating rod has one set of fastening member to push the arc members close to each other to shrink the clamp space. Thus a bearing placed in the clamp space can be firmly clamped through the three clamp portions from three pressing directions without slipping during disassembly.

### FIELD OF THE INVENTION

The present invention relates to a bearing disassembly apparatus and particularly to a pressing disc to hold a bearing to facilitate disassembly thereof.

### BACKGROUND OF THE INVENTION

Please refer to FIG. 1, a bearing disassembly apparatus 2 is commonly used to disassemble a bearing 1. The bearing disassembly apparatus 2 includes two semicircular members 3, two rods 4, a rack 5, a manual compression bar 6 and a thrust rod 7. The two semicircular members 2 have respectively an arc compression surface 8 to firmly hold the circumference of the bearing 1. The rods 4 run through two sides of the semicircular members 3 and are respectively fastened by two nuts 9 to push the two semicircular members 3 close to each other so that the two arc compression surfaces 8 can tightly clamp the bearing 1.

The rack 5 is mounted onto the two semicircular members 3 to suspend the thrust rod 7 to butt the bearing 1; then the manual compression bar 6 is coupled on the thrust rod 7 and moves the thrust rod 7 downwards to press and disassemble the bearing 1.

The aforesaid conventional structure can merely disassemble the bearing 1 of one size of diameter. In the event that the diameter of the bearing 1 is different from the diameter jointly formed by the two arc compression surfaces 8, if the bearing 1 is small, the bearing 1 cannot be securely held and is prone to slip away; if the bearing 1 is large, it will be tightly wedged between the arc compression surfaces 8, or even cannot be held between the arc compression surfaces 8, thus is not operable. Because of the aforesaid conventional technique is not adaptable to the bearing 1 of varying sizes, it cannot fully meet use requirements.

### SUMMARY OF THE INVENTION

Therefore the primary object of the present invention is to provide a clamp structure adaptable to bearings of varying sizes to form secure clamp thereof.

To achieve the foregoing object, the invention provides a pressing disc for disassembling bearings. It includes three arc members, three penetrating rods and three sets of fastening members. Each of the three arc members has a clamp portion and a through hole on each of two sides thereof. The three arc members are coupled with each other to allow any one through hole of any one arc member to communicate with the opposing through hole of the neighboring arc member to form a channel. The three clamp portions are also connected with each other to form a clamp space. The three penetrating rods respectively run through the channel, and the three sets of fastening members are mounted on the three penetrating rods to push the three arc members close to each other to shrink the clamp space.

Therefore, a bearing is placed in the clamp space, and the three sets of fastening members can push the three arc members close to each other to shrink the clamp space and clamp the bearing from three pressing directions. Thus even if the diameters of the bearings are varied, they still can be firmly clamped without slipping during disassembly.

The foregoing, as well as additional objects, features and advantages of the invention will be more readily apparent from the following detailed description, which proceeds with reference to the embodiment and accompanying drawings. The embodiment serves merely for illustrative purpose and is not the limitation of the invention

### BRIEF DESCRIPTION OF THE DRAWINGS

FIG. 1 is a schematic view of a conventional bearing disassembly apparatus in a use condition.

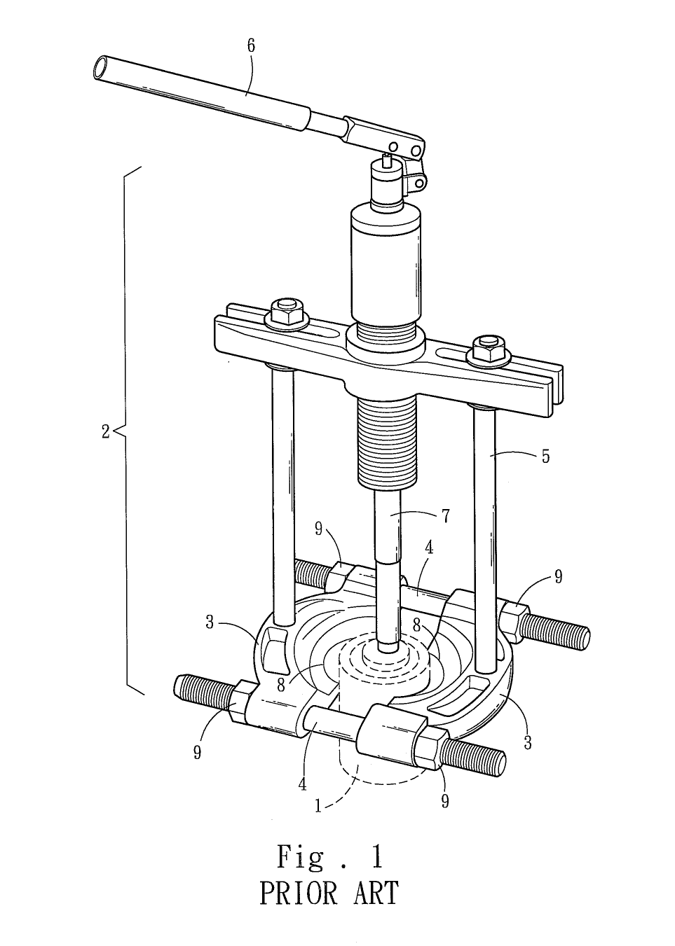

FIG. 2 is a perspective view of the invention.

FIG. 3 is a fragmentary exploded view of the invention.

FIG. 4 is a perspective view of the invention for clamping a bearing.

FIG. 5 is a fragmentary sectional view the invention for clamping a bearing.

FIG. 6 is a schematic view of the invention for clamping another bearing.

### DETAILED DESCRIPTION OF THE PREFERRED EMBODIMENT

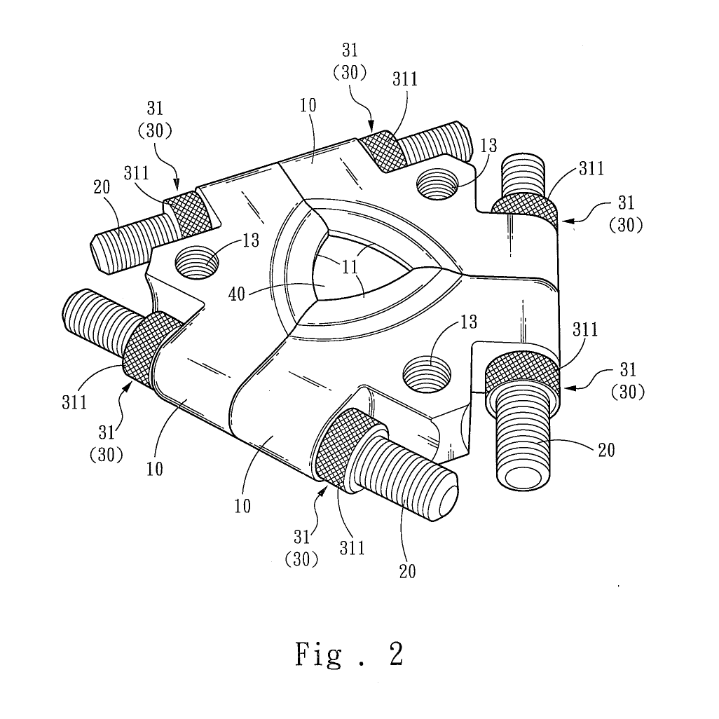

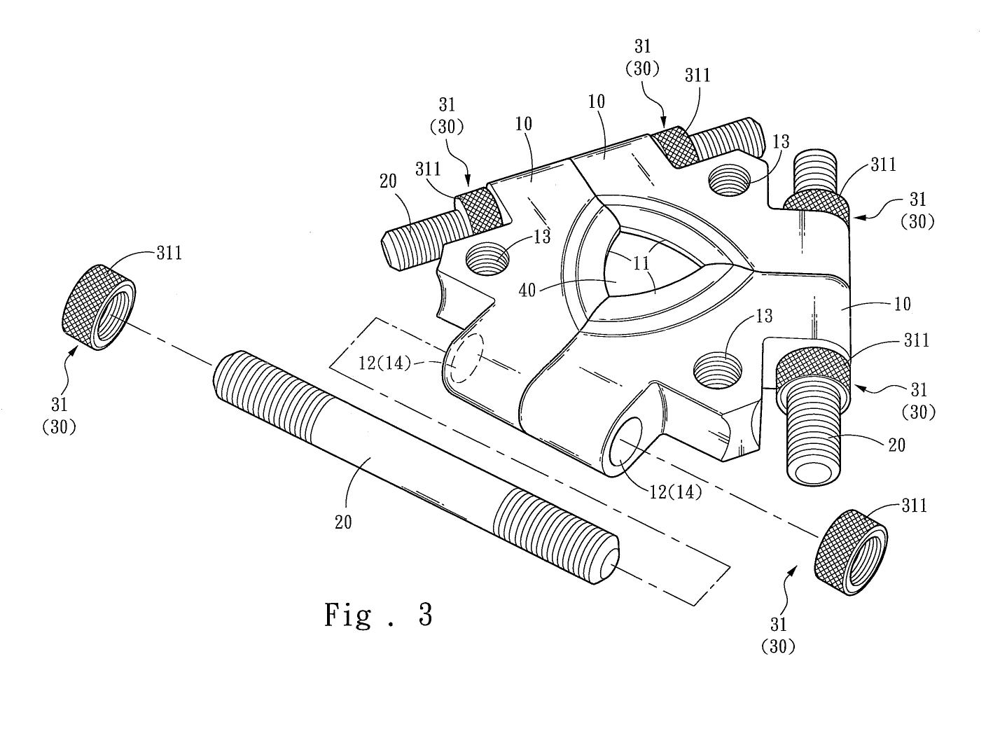

Please refer to FIGS. 2 and 3, the present invention aims to provide a pressing disc for disassembling bearings. It includes three arc members 10, three penetrating rods 20 and three sets of fastening members 30. Each of the three arc members 10 has a clamp portion 11 and a through hole 12 on each of two sides thereof. The three arc members 10 are coupled with each other to allow any one through hole 12 of any one arc member 10 to communicate with the opposing through hole 12 of the neighboring arc member 10 to form a channel 14. The three clamp portions 11 also are connected with each other to form a clamp space 40. The three penetrating rods 20 respectively run through the channel 14. The three sets of fastening members 30 are mounted on the three penetrating rods 20 to push the three arc members 10 close to each other to shrink the clamp space 40.

Each of the three sets of fastening members 30 has two screw fasteners 31 screwing on two sides of each penetrating rod 20 to push the arc members 10 close to each other. Each screw fastener 31 has anti-slipping traces 311 to facilitate operation thereof.

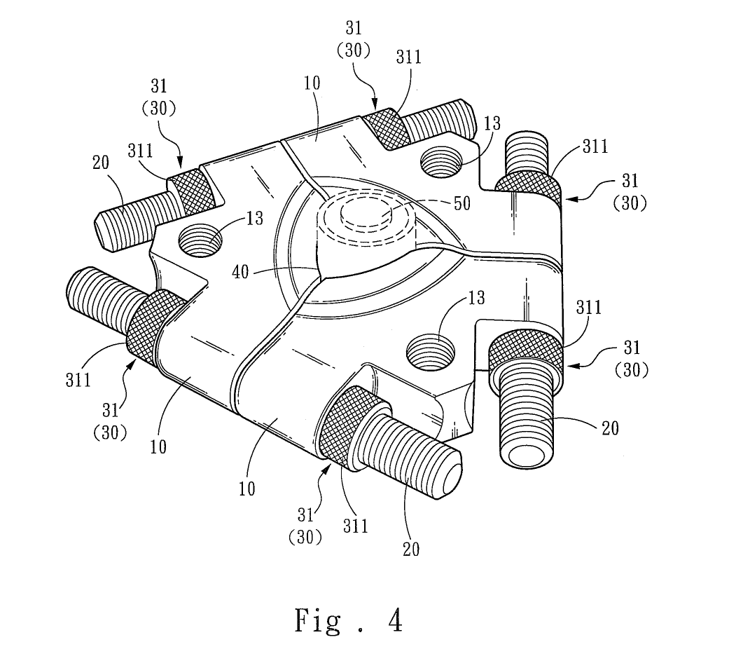

Referring to FIG. 4, a bearing 50 is placed in the clamp space 40 and clamped by the shrunk clamp space 40 when the three arc members 10 are pushed close to each other through the three sets of fastening members 30.

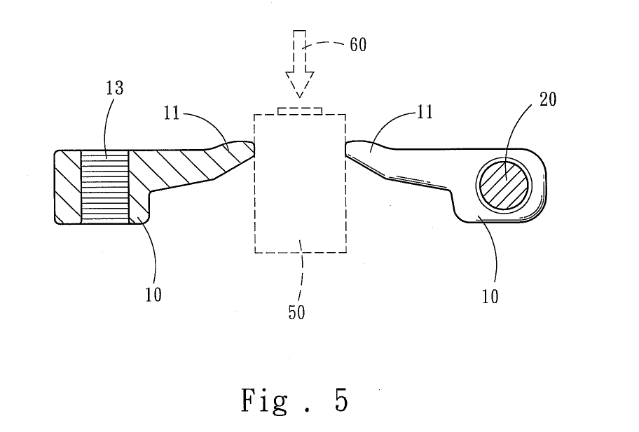

Referring to FIG. 5, each clamp portion 11 is formed in an arc plank shape and is extended upwards in an inclined manner to form an upward bracing structure. Hence a desired fastening effect is formed when the bearing 50 receives a downward disassembly force 60. Such a structure also can prevent the bearing 50 from slipping. Each arc member 10 also has a screw hole 13 to hold a rack (not shown in the drawings) during disassembly of the bearing 50.

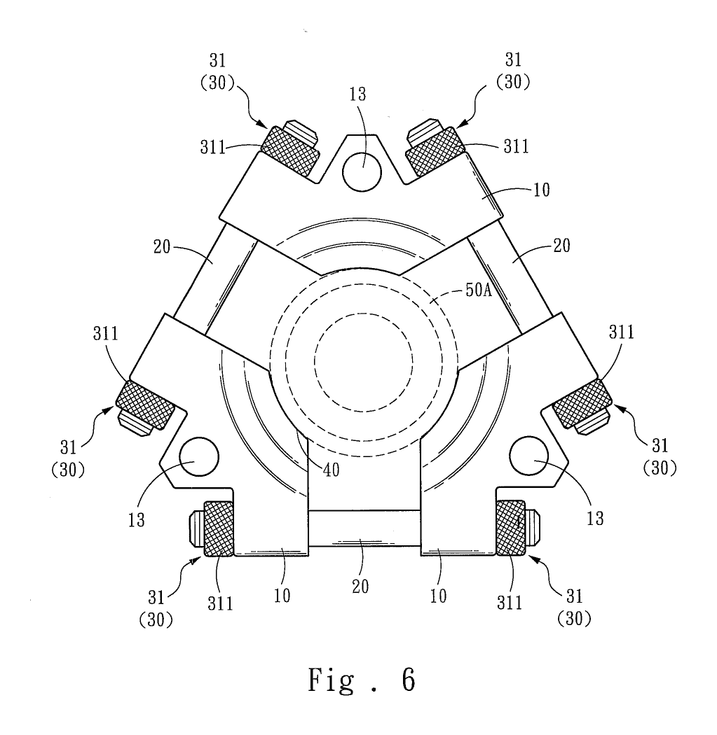

Also referring to FIG. 6, when the bearing 50A is formed in a different dimension, it also can be clamped from three directions by changing the positions of the six screw fasteners 31, namely the dimension of the clamp space 40 is enlarged to fit the bearing 50A with a larger dimension. Hence even if the bearing 50A is formed in different diameters, it still can be firmly clamped without slipping during disassembly, thus use requirements can be met.

In short, the invention can shrink the clamp space 40 by pushing the three arc members 10 close to each other to firmly clamp the bearings 50 and 50A with varying diameters to meet use requirements.

What is claimed is:

1. A pressing disc for disassembling bearings, comprising:
three arc members each including a clamp portion and a through hole on each of two sides thereof, the three arc members being coupled with each other to allow any one through hole of any one arc member to communicate with the opposing through hole of the neighboring arc member to form a channel, the three clamp portions being connected with each other to form a clamp space;
three penetrating rods respectively running the channel; and
three sets of fastening members located on the three penetrating rods to push the three arc members close to each other to shrink the clamp space.

2. The pressing disc for disassembling bearings of claim 1, wherein each of the three sets of fastening members includes two screw fasteners screwing on two sides of each of the three penetrating rods to push the arc members close to each other.

3. The pressing disc for disassembling bearings of claim 2, wherein each of the screw fasteners includes anti-slipping traces.

4. The pressing disc for disassembling bearings of claim 1, wherein each arc member includes a screw hole.

5. The pressing disc for disassembling bearings of claim 1, wherein the clamp portion is formed in an arch plank shape.

6. The pressing disc for disassembling bearings of claim 5, wherein the clamp portion is extended upwards in an inclined manner.
